(19) United States
(12) Patent Application Publication
(10) Pub. No.: US 2011/0197864 A1
(43) Pub. Date: Aug. 18, 2011

(54) Internal combustion engine and method for monitoring a tank ventilation system and a crankcase ventilation system

(76) Inventor: Rolf Karcher, Neckarsulm (DE)

(21) Appl. No.: 12/707,333

(22) Filed: Feb. 17, 2010

(51) Int. Cl. F02B 25/06

(52) U.S. Cl. 123/574

(57) ABSTRACT

The invention relates to an internal combustion engine having an intake air line, which contains both a compressor of an exhaust gas turbocharger and a throttle flap, as well as having a tank ventilation system and a crankcase ventilation system, both of which are connected to the intake air line at two connecting points upstream of the compressor and behind the throttle flap. In order to make it possible to monitor the inlet points of the ventilation gases into the intake air line in a relatively simple way, the invention proposes that a non-return valve be mounted directly at each of the connecting points.

The invention relates to a method for monitoring a tank ventilation system and a crankcase ventilation system of an internal combustion engine according to the preamble of claims 10 to 12.

### BACKGROUND OF THE INVENTION

DE 103 00 592 A1 discloses an internal combustion engine of the type that is described in the introductory part and that has both a tank ventilation system and a crankcase ventilation system. The tank and/or crankcase ventilation gases, which are evacuated from the tank and/or crankcase ventilation system, are recycled into the combustion process by conveying these gases into an intake air line of the internal combustion engine. There are two separate ventilation lines between both the tank ventilation system and the intake line as well as between the crankcase ventilation system and the intake line. In this case, one of the ventilation lines empties into the intake air line upstream of the compressor of the exhaust gas turbocharger, and the other ventilation line empties into the intake air line behind the throttle flap. The two ventilation lines, which empty into the intake air line upstream of the compressor of the exhaust gas turbocharger, serve to vent the tank and/or the crankcase under full load, whereas the ventilation lines, which empty into the intake air line behind the throttle flap, serve to vent the tank and/or the crankcase under partial load. All of the ventilation lines are provided with valves having an adjustable opening degree.

Since a defect in the tank ventilation system and/or the crankcase ventilation system would result in the unburned hydrocarbons escaping into the environment, most countries have already mandated for some time now the use of diagnostic methods that make it possible to diagnose whether the tank ventilation system and the crankcase ventilation system are operating correctly, in order to detect early warning symptoms caused by defects that would result in the escape of unburned hydrocarbons and to remedy these defects. However, the California Air Resource Board (CARB) requires additionally that Otto cycle engines equipped with turbochargers shall now also be provided with additional monitoring of the inlet points, at which the tank ventilation gases and the crankcase ventilation gases are fed into the intake air line. The intent of this strategy is to suppress the undesired emission of unburned hydrocarbons into the environment as a consequence of disconnecting the connections at the connecting points.

While the monitoring of the connecting point of the tank ventilation line(s) and the crankcase ventilation line(s) that empty into the intake air line behind the throttle flap and that serve during the intake operation to feed the ventilation gases into the intake air line does not cause any problems, the connecting point of the tank ventilation line(s) and the crankcase ventilation line(s) that empty into the intake air line upstream of the compressor of the exhaust gas turbocharger and through which the ventilation gases are fed into the intake air line during the supercharging operation can be monitored only with difficulty. This problem applies predominantly when the charging of the cylinder of the internal combustion engine is not calculated from the measurement values of an air flow sensor, which is fitted into the intake air line in the flow direction of the intake air upstream of the compressor, but rather from the measurement values of a so-called intake pipe pressure sensor that is mounted behind the throttle flap in a section of the intake air line that is commonly referred to as the intake pipe and, thus, is mounted behind the inlet point of the ventilation gases during the supercharging operation.

In principle, it would be possible to configure the connections of the tank and crankcase ventilation lines to the intake air line as connections that cannot be disconnected, but then such a solution would cause problems if disassembly became necessary.

In addition, DE 102 49 720 A1 already discloses a pressure regulating valve that is intended for a crankcase ventilation system of an internal combustion engine and that is mounted between a crankcase and an intake pipe of the internal combustion engine and is connected to the intake pipe by means of two ventilation lines, of which one empties into the exhaust gas pipe upstream of a compressor of an exhaust gas turbocharger and the other empties into the exhaust gas pipe behind a throttle flap. Each of the two ventilation lines contains a non-return valve, both of which are integrated into the line connections of the pressure regulating valve.

Working on this basis, the object of the invention is to provide an internal combustion engine and a method of the type that is described in the introductory part and that makes it possible to monitor, in a relatively simple way, the inlet points of the ventilation gases into the intake air line.

### SUMMARY OF THE INVENTION

This object is achieved with the internal combustion engine according to the invention in that a non-return valve is mounted directly at each of the connecting points, at which the ventilation gases are fed into the intake air line.

The invention is based on the idea of shifting the non-return valve, disclosed in DE 102 49 720 A1, away from the pressure regulating valve to the system interfaces of the crankcase ventilation system and/or the tank ventilation system, i.e., directly to the intake air line. As a result, it is possible to monitor with a pressure sensor a leakage between the tank ventilation system and the crankcase ventilation system, on the one hand, and the intake air line, on the other hand, without any additional measures. This pressure sensor is fitted, according to the invention, in the intake air line behind the throttle flap and serves to determine the charging of the cylinder, but can also be used advantageously to monitor the inlet points of the ventilation gases from the tank ventilation system and the crankcase ventilation system into the intake air line during the intake operation and during the supercharging operation.

In order to keep the number of necessary components and the assembly effort low, a preferred embodiment of the invention provides that the tank ventilation system and the crankcase ventilation system are connected jointly to the intake air line at the two connecting points.

At the same time, the pressure sensor can diagnose or determine both a leakage between the tank ventilation system and the crankcase ventilation system, on the one hand, and the intake air line, on the other hand, and also a defect or jamming of an open non-return valve that is mounted directly at the connecting point upstream of the compressor, while a defect or jamming of the closed non-return valve, mounted at the connecting point behind the throttle flap, is determined advantageously in the course of monitoring or diagnosing a tank vent valve of the tank ventilation system.

Whereas, for the sake of ease of replacement, the non-return valve, which is mounted at the connecting point behind the throttle flap, can be detachably connected to the intake air line and a ventilation line that runs to the tank ventilation system and the crankcase ventilation system, the non-return valve, which is mounted at the connecting point upstream of the compressor, is non-detachably connected, according to a preferred embodiment of the invention, to the intake air line. As a result, first of all, beyond this non-return valve it is no longer possible to undo the connection between the tank ventilation system and the crankcase ventilation system, on the one hand, and the intake air line, on the other hand. And secondly, in the event that the pressure in the ventilation line exceeds the ambient pressure, it is possible to prevent the unburned hydrocarbons from escaping into the environment. However, this non-return valve can be detachably connected to the ventilation line, so that in the event of a line rupture, this ventilation line can be disconnected and replaced.

If the non-return valve, which is mounted at the connecting point behind the throttle flap, is disconnected from the intake air line and the ventilation line running to the tank ventilation system and the crankcase ventilation system, or if the non-return valve, which is mounted at the connecting point upstream of the compressor, is disconnected from the ventilation line, then the ventilation line immediately reaches an ambient pressure that in turn makes it possible to detect a leakage.

The invention is explained in detail below by means of one embodiment that is depicted in the drawings.

### BRIEF DESCRIPTION OF THE DRAWINGS

FIG. 1 is a schematic drawing of parts of an internal combustion engine that is equipped with an exhaust gas turbocharger, a tank ventilation system, and a crankcase ventilation system.

FIG. 2 is a drawing of the pressure in the intake air line upstream of the compressor of the exhaust gas turbocharger and behind a throttle flap as a function of the load and the rotational speed of the internal combustion engine.

### DETAILED DESCRIPTION OF THE PREFERRED EMBODIMENTS OF THE INVENTION

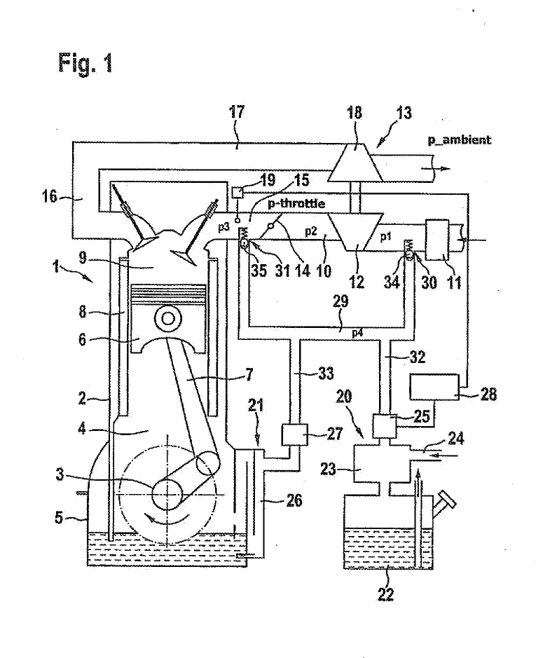

FIG. 1 is a schematic drawing of a sectional view, depicting the parts of a supercharged Otto cycle engine 1 having an engine block 2, a crankcase 5, surrounding the crankshaft 3, and a crank chamber 4 of the internal combustion engine 1, as well as at least one piston 6, which is connected to the crankshaft 3 by means of a connecting rod 7 and which moves up and down in a related cylinder 8 of the engine 1. The air that is required to burn the mixture of fuel and air in a combustion chamber 9 of the cylinder 8 is fed to the combustion chamber 9 through an intake air line 10 that contains an air filter 11, a compressor 12 of an exhaust gas turbocharger 13, and a throttle flap 14. The throttle flap 14 is fitted in the flow direction of the air behind the compressor 12 and upstream of a section of the intake air line 10 that is commonly referred to as the intake pipe 15. The combustion air from the combustion chamber 9 of the cylinder 8 is evacuated through an exhaust gas manifold 16 and an exhaust gas pipe 17, which contains a turbine 18 of the exhaust gas turbocharger 13. In order to charge the cylinder 8 and/or to determine the air mass fed into the cylinder 8, there is a pressure sensor 19 behind the throttle flap 14 in the intake pipe 15. This pressure sensor is used to measure the intake pipe pressure, from which then the air mass is calculated according to the equation p·V=m·T.

In order to prevent an emission of unburned hydrocarbons into the environment, the internal combustion engine 1 additionally has a tank ventilation system 20 and a crankcase ventilation system 21.

The tank ventilation system 20 makes it possible to ventilate a fuel tank 22 of the internal combustion engine 1; and the fuel vapors or tank ventilation gases, evacuated from the fuel tank 22, are fed into the intake air line 10, for combustion in the cylinder 8. The tank ventilation system 20 comprises a fuel vapor storage container 23, which communicates with the fuel tank 22 and is filled with active charcoal. This storage container temporarily holds the fuel vapors or the tank ventilation gases. In order to regenerate the active charcoal, the tank ventilation system also comprises a regenerating line 24, through which the air from the environment is taken into the intake air line 10 through the storage container 23, when a tank vent valve 25, which is fitted between the storage container 23 and the intake air line 10, is opened.

The crankcase ventilation system 21 makes it possible to actively ventilate the crank chamber 4 of the internal combustion engine 1 by feeding the air under controlled conditions into the crankcase 5 and by feeding the crankcase ventilation gases—that is, the air that has been fed in and mixed with the oil vapor from the crank chamber 4—as well as the so-called blow-by gases—that is, the combustion gases passing through between the cylinder 8 and the piston 6 when the internal combustion engine 1 is running—into the intake air line 10 also for combustion purposes. The crankcase ventilation system 21 comprises an oil separator 26, which communicates with the crank chamber 4, and a pressure regulating valve 27, which is mounted between the oil separator 26 and the intake air line 10.

In order to monitor whether the tank ventilation system 20 and the crankcase ventilation system 21 are operating correctly, there is a diagnosis module 28 that is connected to the tank vent valve 25, the pressure regulating valve 27 and the pressure sensor 19.

The tank vent valve 25 of the tank ventilation system 20 and the pressure regulating valve 27 of the crankcase ventilation system 21 are connected to the intake air line 10 by means of a common ventilation line 29. The one end of this ventilation line 29 is connected to the intake air line 10 at a first connecting point 30 behind the air filter 11 and upstream of the compressor 12; and the opposite end of this ventilation line is connected to the intake air line 10 at a second connecting point 31 behind the throttle flap 14. Moreover, this ventilation line communicates between the two ends via two branches 32 and 33 with the tank vent valve 25 of the tank ventilation system 20 and/or the pressure regulating valve 27 of the crankcase ventilation system 21, so that the ventilation line 29 is used jointly by the tank ventilation system 20 and the crankcase ventilation system 21.

At each of the two connecting points 30 and 31, a non-return valve 34 and 35, both of which prevent the air from the intake air line 10 from entering into the common ventilation line 29, is mounted directly. First of all, this non-return valve ensures that no air can flow past the compressor 12 and the throttle flap 14 through the ventilation line 29 and, secondly, that air from the intake air line 10 can flow through the ventilation line 29 and the branches 32 or 33 into the tank ventilation system 20 or the crankcase ventilation system 21. The non-return valve 34 at the first connecting point 30 is non-detachably connected to the intake air line 10 and is detachably connected the one end of the ventilation line 29, whereas the non-return valve 35 at the second connecting point 31 can be detachably connected to the intake air line 10 and to the opposite end of the ventilation line 29.

During the supercharging operation of the exhaust gas turbocharger 13, the tank ventilation gases and the crankcase ventilation gases are fed through the open non-return valve 34 into the intake air line 10 at the first connecting point 30 as a result of the pressure conditions in the intake air line 10 and in the ventilation line 29, whereas during the intake operation said gases are fed through the open non-return valve 35 into the intake air line 10 at the second connecting point 31.

FIG. 1 shows that a pressure p1 in the intake air line 10 upstream of the compressor 12 is less than or equal to the ambient pressure p_ambient, whereas a pressure p2 in the intake air line 10 behind the compressor 12 and upstream of the throttle flap 14 is equal to the sum of the pressure conditions p1+p_charge, where p-charge is the charging pressure of the compressor 12. The pressure p3 in the intake pipe 15 behind the throttle flap 14 is equal to the difference between the pressure conditions p2−p_throttle, where p_throttle is the pressure loss at the throttle flap 14.

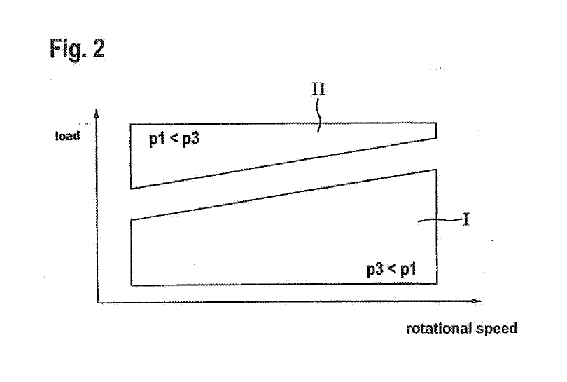

FIG. 2 shows the relationship between p1 and p3 as a function of the load and the rotational speed of the internal combustion engine 1, area I reflecting the relationship during the intake operation, and area II reflecting the relationship during the supercharging operation.

The pressure in the ventilation line 29 is designated as p4 and corresponds to the lower pressure of p1 and p3 respectively, because during both the intake operation and the supercharging operation one of the two non-return valves 34, 35 is open in each case. This means, on the other hand, that apart from the special case p1=p3, one of the two non-return valves 34, 35 must always be closed.

A slight vacuum prevails upstream of the pressure regulating valve 27 inside the crank chamber 4, i.e., a pressure that is slightly below the ambient pressure p_ambient. This pressure regulation by means of the pressure regulating valve 27 is necessary, because, for example, in idling mode a pressure p4≈p3 occurs that amounts to approximately 300 mbar, a state that would be much too low for the crank chamber 4 in idling mode.

In the event that the connection at the first connecting point 30 is disconnected, the fixed connection between the non-return valve 34 and the intake air line 10 is necessary in order to prevent ventilation gases from escaping from the ventilation line 29 into the environment when, during the supercharging operation, the pressure p4 in the ventilation line 29 is higher than the ambient pressure p_ambient.

If the ventilation line 29 has a leak, which can occur at any point, for example, owing to a rupture of the ventilation line 29 or owing to the connection between the ventilation line 29 and one of the two non-return valves 34, 35 being disconnected, the pressure p4 inside the ventilation line 29 is equal to the ambient pressure p_ambient. Since in this state the tank ventilation gases or the crankcase ventilation gases can escape from the ventilation line 29 into the environment, such a state has to be detected by the diagnosis. This is also the case in the described tank and crankcase ventilation system, because either the idling speed during the intake operation is too high and cannot be adjusted owing to the infeed of too much fresh air into the intake pipe, because the intake pipe pressure, which is measured to balance the charging, is implausible in relation to the position of the throttle flap 14, or the diagnosis of the tank ventilation results in the detection of a leak.

If the non-return valve 34 jams in its open position, the pressure p4 inside the ventilation line 29 is equal to the pressure p1. This situation during a supercharging mode causes the air to be taken from the environment through the non-return valve 34, as a result of which the leakage flow into the intake pipe 15 is somewhat less, but the pressure p3 in the intake pipe 15 that is measured by the pressure sensor 19 also rises and makes it possible for a leak to be detected.

When the non-return valve 34 jams in its closed position, this situation alone cannot be diagnosed with the aid of the pressure sensor 19. In such a case, however, the ventilation gases from the tank ventilation system 20 and the crankcase ventilation system 21 can be fed into the intake pipe 15 through the non-return valve 35 at the second connecting point 31 during the intake operation, if the pressure p4 is higher than the pressure p3.

If the non-return valve 35 jams in its closed position, this situation can be detected by a diagnosis of the tank vent valve 25, a feature that, with respect to the crankcase ventilation; results in an improvement over the systems known from the prior art.

1. An internal combustion engine having an intake air line, which contains both a compressor of an exhaust gas turbocharger and a throttle flap, as well as having a tank ventilation system and a crankcase ventilation system, both of which are connected to the intake air line at two connecting points upstream of the compressor and behind the throttle flap, wherein a non-return valve is mounted directly at each of the connecting points.

2. The internal combustion engine, according to claim 1, wherein the tank ventilation system and the crankcase ventilation system are connected jointly to the intake air line at the two connecting points.

3. The internal combustion engine, according to claim 1 or including a ventilation line that runs from the tank ventilation system and from the crankcase ventilation system to the two connecting points.

4. The internal combustion engine, according claim 1 wherein the non-return valve, which is mounted at the connecting point upstream of the compressor, is non-detachably connected to the intake air line.

5. The internal combustion engine, according to claim 4 wherein the non-return valve is detachably connected to a ventilation line that runs from the tank ventilation system and from the crankcase ventilation system to the two connecting points.

6. The internal combustion engine, according to claim 4 wherein the non-return valve, which is mounted at the connecting point behind the throttle flap, is detachably connected to the intake air line and a ventilation line that runs from the tank ventilation system and from the crankcase ventilation system to the two connecting points.

7. The internal combustion engine, according to claim 3 wherein the tank ventilation system (20) includes a tank vent valve (25) that is connected to the ventilation line.

8. The internal combustion engine, according to claim 3 wherein the crankcase ventilation system includes a pressure regulating valve that is connected to the ventilation line.

9. The internal combustion engine, according to claim 1 wherein a pressure sensor is mounted behind the throttle flap in the intake air line, in order to determine the cylinder charging.

10. A method for monitoring a tank ventilation system and a crankcase ventilation system of an internal combustion engine, both of which are connected to an intake air line of the internal combustion engine at two connecting points upstream of a compressor of an exhaust gas turbocharger and behind a throttle flap, comprising determining a leakage between the tank ventilation system and the crankcase ventilation system, on the one hand, and the intake air line, on the other hand, by monitoring the pressure behind the throttle flap.

11. The method for monitoring a tank ventilation system and a crankcase ventilation system of an internal combustion engine, both of which are connected to an intake air line of the internal combustion engine by means of non-return valves at two connecting points upstream of a compressor of an exhaust gas turbocharger and behind a throttle flap, comprising determining a defect or jamming of the open non-return valve that is mounted at the connecting point upstream of a compressor by monitoring the pressure behind the throttle flap.

12. The method for monitoring a tank ventilation system and a crankcase ventilation system of an internal combustion engine, both of which are connected to an intake air line of the internal combustion engine by means of non-return valves at two connecting points upstream of a compressor of an exhaust gas turbocharger and behind a throttle flap, comprising determining a defect or jamming of the closed non-return valve that is mounted at the connecting point behind the throttle flap by a diagnosis of a tank vent valve of the tank ventilation system.

13. The internal combustion engine having an intake conduit including a compressor of a supercharger and a throttle flap, a fuel tank ventilation system and crankcase ventilation system, a venting system comprising:
a first conduit communication with said intake conduit at a first point upstream of said compressor, having a one-way valve disposed at said first point, allowing flow only into said intake conduit, and at a second point downstream of said throttle flap, having a one-way valve disposed at said second point, allowing flow only into said intake conduit;
a second conduit intercommunicating said fuel tank ventilating system and said first conduit; and
a third conduit intercommunicating said crankcase ventilating system and said first conduit.

14. A system according to claim 13 wherein said first mentioned one-way valve is undetachably connected to said intake conduit and detachably connected to said first conduit.

15. A system according to claim 13 wherein said second mentioned one-way valve is detachably connected to each of said intake conduit and said first conduit.

16. A system according to claim 13 including a pressure sensor disposed in said intake conduit downstream of said throttle flap.

17. A system according to claim 16 including means for diagnosing signals generated by said pressure sensor.

18. A system according to claim 16 including pressure regulating valves disposed in said second and third conduit operable responsive to signals generated by said pressure sensor.
